(19) United States
(12) Patent Application Publication
(10) Pub. No.: US 2017/0195869 A1
(43) Pub. Date: Jul. 6, 2017

(54) METHOD AND SYSTEM FOR MANAGING USER ACCOUNT DATA FOR A ROAMING MOBILE COMMUNICATIONS DEVICE

(71) Applicant: GLOBETOUCH AB, Stockholm (SE)

(72) Inventors: Bjorn KNUDSEN, HASSELBY (SE); Fredrik SALQVIST, OSTERSKAR (SE)

(21) Appl. No.: 15/313,850

(22) PCT Filed: May 26, 2015
(86) PCT No.: PCT/SE2015/050603

§ 371 Date: Nov. 23, 2016

(30) Foreign Application Priority Data
May 27, 2014 (SE) 1450632-3

(51) Int. Cl. H04W 8/18; H04W 8/12; H04M 15/00

(52) U.S. Cl. CPC H04W 8/18; H04M 15/7556; H04M 15/8038; H04W 8/12

(57) ABSTRACT

Method and system for managing user account data in a virtual mobile communication system operable in two groups (100,200) of mobile communication networks (110,120,130) between which a mobile communication device can roam, the method including:
a) providing a first group gateway node (111) and interconnected BSS (112), keeping a user account associated with the user on the first BSS;
b) providing a second group gateway node (211) and interconnected BSS (212);
c) when the device is in the first group, routing usage information communications via a first group serving node (125,135) and the first BSS, which updates the user account data;
d) when the device is in the second group, routing usage information communications via a second group serving node (225,235) and the second BSS, causing the second BSS to locate the first BSS and to provide the first BSS with the usage information for updating the user account.

The present invention relates to a method and a system for roaming of a mobile communications device between mobile communication networks in different countries. More specifically, the invention relates to such a method and system for roaming within a virtual mobile communications network in which a virtual mobile operator collaborates with the physical mobile communication networks of several network operators.

Presently, it is common for mobile operators to have national mobile communication networks, such as networks for mobile data and/or voice communication, for example GSM, GPRS, 3G, LTE, etc. When a mobile communication device is brought outside of the coverage area of a certain network and into the coverage area of the network of another operator, conventional roaming gives rise to problems with high and unpredictable costs for data and/or voice communication.

These problems are especially common when it comes to mobile data traffic, where costs during roaming with variable tariffs can amount to more than 1000 times higher per data unit as compared to mobile data traffic in the home network. Many times there are no efficient ways of keeping track of the costs during a stay abroad or the like. As a consequence, a user risks unpleasant surprises regarding mobile data costs when returning from a stay within the coverage area of the network of a foreign operator.

The international patent application PCT/SE2011/050886 describes a method according to which a local IMSI is automatically distributed to a SIM card in a mobile device roaming into a visited country. This way, a user roaming in a network which is not the home network of the user can be provided mobile communication services at local tariffs.

Typically, an operator will want to implement a virtual mobile communications network using such a system, or a similar system, in cooperation with the physical mobile communications networks of other network operators. In such a virtual network, it is desirable that users can be provided international roaming services while the operator keeps track of the amount of data used, such as deducting consumed data traffic from a prepaid amount of data traffic. Normally, a Business Support Server (BSS) is implemented, which keeps user account information including current usage information, and via which a user for instance can purchase or manage connectivity.

There are a number of problems with setting up such a virtual network.

Firstly, there is a problem choosing the geographic location of the central BSS holding all the up-to-date account and usage data for roaming and non-roaming users. The central BSS must keep track of account and current usage data in near real time, irrespectively of whether a certain user is present in a respective home network, roams in a foreign network geographically close to the BSS or roams in a foreign network geographically distant from the BSS. Therefore, it is difficult to find one location from where the BSS is able to provide low-latency service to all users.

Secondly, due to regulatory reasons, mobile traffic must in some instances terminate in a Gateway GPRS Support Node (GGSN) arranged locally in for instance a certain country. Correspondingly, for an LTE network, there may be regulatory restrictions regarding the arrangement of a local PGW (Packet data network GateWay). This in turn limits the possibilities to obtain a correct view of current data usage without actually having locally arranged BSS functionality in the country in question.

At the same time, in order to simplify system setup and usage, it is desired to be able to use one single Uniform Resource Locator (URL) using which a user can access BSS functionality. Furthermore, it is desirable to be able to use one single Access Point Name (APN) using which each participating mobile communication device connects to the internet. It would also be desirable to use such a single URL and a single APN uniformly throughout the virtual network, so that no localization or manual configuration is necessary in connection to roaming.

Furthermore, it is desirable for a user to be able to use such a single URL, irrespectively of in what network he or she roams, and also irrespectively of whether the user is using the actual mobile communications network to access the said URL or any other internet connection channel.

Finally, it is desirable that mobile communication services provided to each user operate as seamlessly as possible during roaming at all times, so as to negatively affect as little as possible the user experience.

The present invention solves the above described problems.

Thus, the invention relates to a method for managing user account data in a virtual mobile communication system operable in one or several participating mobile communication networks belonging to a first group of such networks as well as one or several mobile communication networks belonging to a second group of such networks, which second group comprises different networks than the first group, wherein a mobile communication device of a user can roam between said first and second network groups, which mobile communication device is caused to comprise a SIM (Subscriber Identity Module) card identifying itself to each network using an IMSI (International Mobile Subscriber Identity) code, wherein the SIM card is caused to identify itself with different IMSI codes when roaming in different participating networks, characterized in that the method comprises the steps of providing a first gateway node and a first BSS (Business Support System), said first gateway node and said first BSS being interconnected and arranged to serve mobile communication devices being provided mobile communication services in said first group of networks, and keeping a user account associated with the user on the first BSS; b) providing a second gateway node and a second BSS, said second gateway node and said second BSS being interconnected and arranged to serve mobile communication devices being provided mobile communication services in said second group of networks; c) when the mobile communication device is provided with mobile communication services in the first network group, routing communications via a first serving node (125,135), comprised in the first group, and the first gateway node, causing the first gateway node to provide the first BSS with usage information relating to said communications, and causing the first BSS to update the user account data using said information; d) when the mobile communication device is provided with mobile communication services in the second network group, routing communications via a second serving node, comprised in the second group, and the second gateway node, causing the second gateway node to provide the second BSS with usage information relating to said communications, causing the second BSS to locate the first BSS as a BSS keeping the user account data of the said user, to provide the first BSS with information corresponding to said usage information, and causing the first BSS to thereupon update the user account using the received information.

Further, the present invention relates to a system for managing user account data in a virtual mobile communication system operable in one or several participating mobile communication networks belonging to a first group of such networks as well as one or several mobile communication networks belonging to a second group of such networks, in which virtual mobile communication system a mobile communication device of a user can roam between said first and second network groups, which mobile communication device comprises a SIM (Subscriber Identity Module) card identifying itself to each network using an IMSI (International Mobile Subscriber Identity) code, wherein the SIM card is arranged to identify itself with different IMSI codes when roaming in different participating networks, characterized in that the system comprises a first gateway node and a first BSS (Business Support System), said first gateway node and said first BSS being interconnected and arranged to serve mobile communication devices being provided mobile communication services in said first group of networks, and keeping a user account associated with the user on the first BSS; and a second gateway node and a second BSS, said second gateway node and said second BSS being interconnected and arranged to serve mobile communication devices being provided mobile communication services in said second group of networks; wherein, when the mobile communication device is provided with mobile communication services in the first network group, the system is arranged to route communications via a first serving node, comprised in the first group, and the first gateway node, whereby the first gateway node is arranged to provide the first BSS with usage information relating to said communications and whereby the first BSS is arranged to update the user account data using said information; and wherein, when the mobile communication device is provided with mobile communication services in the second network group, the system is arranged to route communications via a second SGSN, comprised in the second group, and the second gateway node, whereby the second gateway node is arranged to provide the second BSS with usage information relating to said communications, whereby the second BSS is arranged to locate the first BSS as a BSS keeping the user account data of the said user and to provide the first BSS with information corresponding to said usage information, and whereby the first BSS is arranged to thereupon update the user account using the received information.

In the following, the invention will be described in detail, with reference to the appended drawings, where:

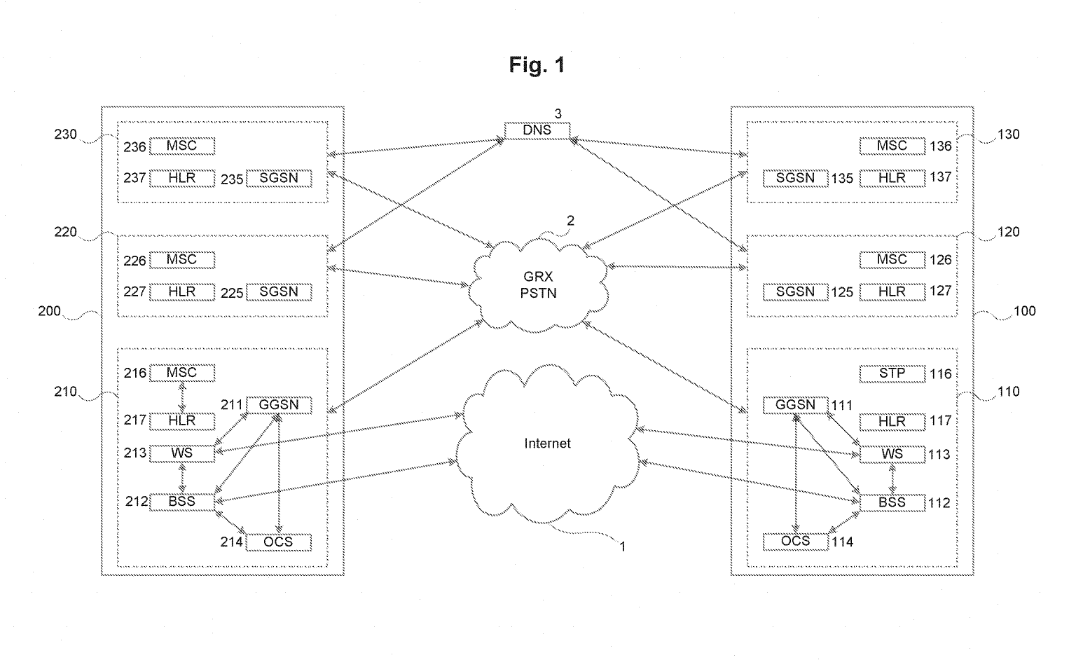

FIG. 1 is a simplified overview diagram of a system according to the present invention for use in a method according to the present invention; and

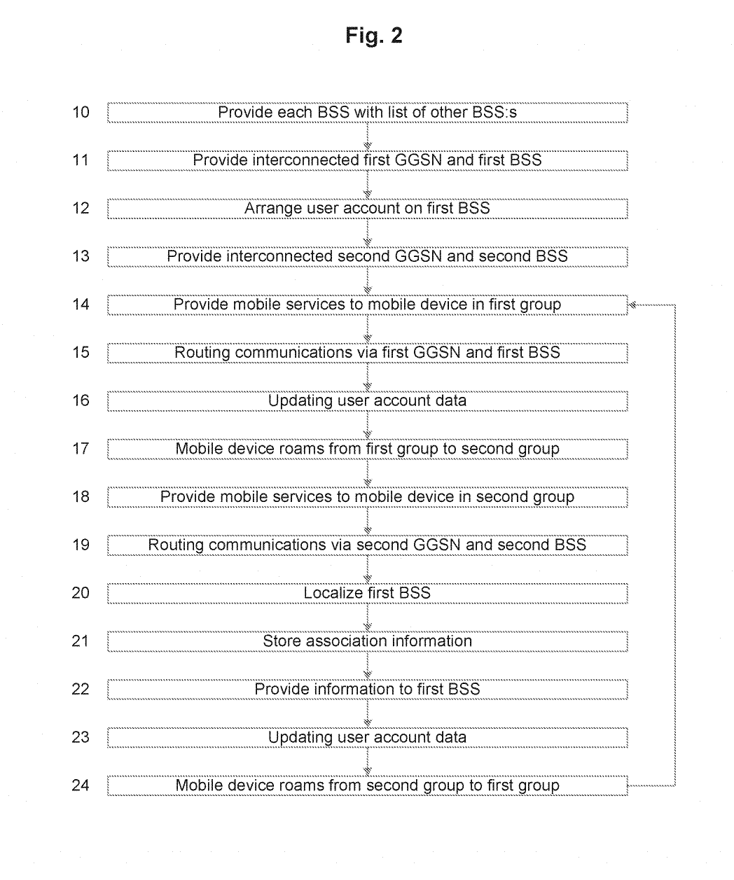

FIG. 2 is a flow chart of a method according to the present invention.

In the figures, as well as in the following description, the present invention is described in terms of a network using GPRS (General Packet Radio Service) core network functionality, such as a 2G or 3G network allowing internet traffic. Specifically, the network described is a GSM network. As such, components such a GGSN (Gateway GPRS Support Node), an SGSN (Serving GPRS Support Node) and a HLR (Home Location Register) are described and used. However, it is realized that the present invention is equally applicable in any other mobile communication system permitting and using packet data traffic, such as an LTE (Long Term Evolution) network. In the LTE example, the entities corresponding to GGSN, SGSN and HLR are PGW (Packet data network GateWay), SGW (Serving GateWay) and HSS (Home Subscriber Server), respectively. Herein, the term “gateway node” is intended to mean a GGSN, a PGW or any other corresponding gateway node, depending on the network type. The term “serving node” is intended to mean an SGSN, an SGW or any other corresponding serving node.

For reasons of simplicity, many examples described in the following specifically relate to a GSM GPRS network. However, it is realized that these examples can be translated into for instance an LTE context in a straightforward way.

FIG. 1 illustrates a first group 100 of mobile communication networks and a second group 200 of mobile communication networks. The first group 100 comprises mobile communication networks 110, 120 and 130; the second group 200 comprises mobile communication networks 210, 220 and 230. In embodiments of the present invention, a virtual mobile communication system is operable in several participating mobile communication networks, such as mobile networks 110, 120, 130, 210, 220 and 230, which networks are distributed into at least two different such groups 100, 200 of mobile communication networks. In other words, the virtual system is operable in individual networks across at least two, preferably at least three, such groups of networks. In general, the groups are different in the sense that at least two such groups in which the virtual system is operable comprise different networks.

Herein, that the system is “virtual” is intended to mean that the system is distributed across several individual networks, and that there is at least one network for which an operator of the virtual system is not the operator. In one preferred embodiment, the virtual network operator is not the operator of any of the networks participating in the virtual network. In these cases, mobile communication services are provided by each mobile communication network in which a user with a mobile device presently roams, in cooperation under suitable agreement between the operator of each individual network and the operator of the virtual system.

Preferably, all communication traffic resulting from the use of such mobile communication services terminates in a node that is controlled by the operator of the virtual network.

Hence, according to the invention a mobile communication device (not shown in FIG. 1) of a user can roam between said first 100 and second 200 network groups, by moving into the coverage area of respective individual ones of the networks 110, 120, 130, 210, 220, 230 being comprised in either group 100, 200.

Said mobile communication device is caused to comprise a SIM (Subscriber Identity Module) card, identifying itself to each such network using an IMSI (International Mobile Subscriber Identity) code. The mobile device can be of any suitable type, such as a mobile phone or a mobile data modem.

In general, one of the mobile communications networks 110, 120, 130, 210, 220, 230, or another mobile communications network (not shown), is a home network to the said mobile communications device. In other words, the mobile device is a subscriber to the said home network. In FIG. 1, purely for exemplifying purposes, the home network of the mobile communications device is the network 110.

The home network 110 comprises a Signal Transfer Point (STP) 116 or, in case LTE is used, an MME (Mobile Management Entity) (or a DRA, Diameter Routing Agent, in case SS7 is used for signaling, as the case may be, even if it is preferred to use signaling over the internet 1 using an STP or an MME), a Home Location Register (HLR) 117 and a Gateway GPRS Support Node (GGSN) 111. The home network 110 can, however, be of any general type, preferably which is able to provide access to mobile communication services to the class of mobile devices which use SIM cards for network identification. In FIG. 1, the home network 110 is a GSM/GPRS network, but it is realized that other types of mobile communication networks in which a mobile communication device is identified using a SIM card are also possible to use with the present invention, such as a 3G and LTE network. The same is true regarding the below described networks 120, 130, 210, 220 and 230.

Preferably, the networks 110, 120, 130, 210, 220, 230 are operable in different countries. The term “country” is used simply to indicate a geographical location for the network in question, and does not imply a certain nationality of the mobile device user, of an operator or such.

The network 120 is similar to the home network 110, and also comprises corresponding components including an MSC 126 and a HLR 127. The network 120 further comprises a Serving GPRS Support node (SGSN) 125. The corresponding is true regarding network 130, which comprises an MSC 136, a HLR 137 and an SGSN 135.

A mobile device can thus, when located within the coverage area of the home network 110, connect to the home network 110 and hence obtain access to mobile communications services.

Furthermore, the mobile device is capable of roaming from the home network 110 to any one of networks 120, 130 in the first group 100 of networks, which networks are hence in this regard visited networks, and to which the mobile device identifies itself using an IMSI code via its SIM card.

As will become clear in the following, the respective operator of each of the networks 110, 120 has beforehand entered into a respective agreement with the operator of the home network 110 concerning the provision of mobile communication services.

A conventional PSTN (Public Switched Telephone Network) and GRX (Global Roaming Exchange) function 2, that may be separately provided, is set up for PSTN telephone signaling and GPRS traffic routing during roaming. Signaling takes place using a telephony signaling protocol, such as the SS7 protocol or any other suitable protocol, such as the SS7 extension SIGTRAN (SIGnaling TRANsport). PSTN 2 interconnects MSC:s 126, 136, 216, 226, 236 (see below), and possibly also unit 116. Alternatively and preferably, routing of signaling traffic between a roaming mobile communication device and the home network 110 takes place over the internet 1 instead of PSTN 2, using respective STP (Signal Transfer Point) and ITP (Internet Transfer Point) devices (not shown in FIG. 1) in the respective participating networks 110, 120, 130, 210, 220, 230, alternatively MME devices. Such signaling in a distributed network between different participating individual networks is described in Swedish patent application 1251502-9.

Data traffic resulting from use of mobile services such as voice and/or data, on the other hand, is routed via GRX 2, interconnecting the GGSN:s 111, 211 with SGSN:s 125, 135, 225, 235 (see below). Preferably, a mobile communication device is only provided mobile data communication, as opposed to purely voice communication, via the virtual network.

According to the invention, the above discussed SIM card in the mobile communications device is caused to identify itself with different IMSI codes when roaming in different participating networks 110, 120, 130, 210, 220, 230. This can be implemented in different ways. One preferred way of achieving this is the one described in PCT/SE2011/050886, that in short comprises the following steps:

a) Causing the SIM card to identify itself using a home network 110 IMSI;
b) Upon roaming into a first visited network 120, 130, 210, 220, 230, causing the mobile device to perform a network reset or refresh;
c) Causing the home network 110 to detect the network reset or refresh, and as a reaction thereto providing the SIM card with a new IMSI, which is local to the visited network in question;
d) Upon roaming from the first visited network 120, 130, 210, 220, 230 to a second visited network 120, 130, 210, 220, 230, causing the mobile device to detect this roaming activity, and as a reaction thereto causing the mobile device to switch the IMSI for network identification back to the home network 110 IMSI;
e) Further upon the roaming event of step d), causing the mobile device to perform a network reset or refresh; and
f) Continuing from step c).

For the above discussed mobile device having network 110 as its home network, the second group 200 networks 210, 220, 230 are visited network treated in the same way as networks 120, 130 for the purposes of the above described method steps a)-f). For a second mobile communication device, with home network 210 (see below), networks 220, 230, 110, 120, 130 are, in the corresponding way, visited networks for that mobile device.

When roaming across the networks 110, 120 and 130, the mobile device, via said SIM card, will identify itself to the network to which it is presently connected using an IMSI that is local to the network in question, and hence being debited local tariffs for mobile communication services provided to the user of the mobile device by the network in question.

When the mobile device roams within the group 100, in other words within the coverage area of networks 110, 120 or 130, it will be connected to either one of networks 110, 120 and 130, for instance since the coverage areas of networks 110, 120, 130 are different, such as being arranged in different countries and/or regions. Preferably, the mobile device is connected as a local subscriber in the network 110, 120 or 130 to which it is currently connected. This may be accomplished in a way which is conventional as such, using HLR:s 117, 127, 137 and MSC:s 126, 136. The user may also be connected directly to the home network 110.

However, the communication services, in particular mobile data communication services, preferably terminate in one central point for all networks 110, 120, 130 comprised in the group 100. In the exemplifying case illustrated in FIG. 1, this central point is the network 110, which is also the above discussed home network. However, the central termination point may be a separate network which is not the home network of the mobile device, or a separate termination point which in itself is not a mobile communication network. The communication traffic, in particular data communication traffic, is routed from the network to which the mobile device is currently connected to the central point in a way which is conventional as such. In FIG. 1, this routing is performed from SGSN 125, 135 to GGSN 111 in case the mobile device is connected to network 120 or network 130, and internally within network 110 in case the mobile device is connected to network 110.

The central point also comprises a BSS (Business Support System) 112, which is interconnected to the GGSN 111 and arranged to, in cooperation with GGSN 111, serve mobile communication devices being provided mobile communication services in the group 100. The BSS 112 is arranged to keep a respective user account associated with each user being a subscriber to the virtual network and having the network 110 as the home network.

The GGSN 111 will hence route traffic resulting from communication services for mobile communication devices roaming throughout at least networks 120 and 130 in group 100. For such traffic, billing information, for instance in the form of CDR:s (Charging Data Record), will be produced by or on initiative from the GGSN 111, and communicated to the BSS 112. Mobile devices roaming in network 110 may give rise to corresponding internal information flows, so that the BSS 112 receives relevant billing information.

This way, the BSS 112 can keep track in near realtime of the mobile communication services usage of all mobile devices being subscribers to the virtual network and being connected to any network within the group 100. The mentioned user account being held by the BSS 112 preferably also comprises information regarding current subscription plan; any prepaid or limit usage regarding such services, such as amount of mobile data; and/or possible ways to amend the subscription plan or to purchase additional services or connectivity.

In FIG. 1, the DNS function 3, which is connected to and used by all networks 110, 120, 130, 210, 220, 230, is illustrated as an isolated function, but it is understood that it may be a conventional DNS function, which is typically distributed across several locations and network layers, not necessarily interconnected as one connected system.

However, the mobile communication device roaming between networks 110, 120, 130 uses an APN (Access Point Name) indicating that the internet traffic termination point is the GGSN 111 in network 110. Preferably, the above described local IMSI used by the mobile device in each respective network 120, 130 is associated with an APN indicating that the GGSN 111 is to be used as the termination point for traffic to and from the mobile device, such that when the roaming mobile device receives a local IMSI, it also receives an APN pointing to the GGSN 111.

Network 110 further comprises a web server (WS) 113, which is arranged to accept, from the internet 1 or GGSN 111, requests for current subscription status, such as used data quantity; remaining data quantity; terms and conditions or personal data; and/or orders for modifying the subscription or for purchasing additional services. The web server 113 is in communication with the BSS 112 for performing such queries and/or orders with the BSS 112. Preferably, the web server 113 is arranged to provide a GUI (Graphical User Interface) in the form of a web page to a user wanting to manage his or her mobile communication services account on the BSS.

The second group 200 is similar to the first group 100 in the sense that the second group 200 comprises several networks 210, 220, 230, and that the second group 200 is associated with a respective home network for mobile communication devices (which in the exemplifying case illustrated in FIG. 1 is network 210) and a central point for termination of data traffic (which is also network 210). The central point for data termination in the second group 200 is preferably different from the central point for data termination in the first group 100. MSC:s 216, 226, 236; HLR:s 217, 227, 237; SGSN:s 225, 235; GGSN 211; web server WS 213; and BSS 212 have the corresponding functionality in the group 200 as the corresponding parts 116, 126, 136, 117, 127, 137, 125, 135, 111, 113 and 112, respectively, in the group 100, but with respect to mobile communication devices having a respective user account kept by BSS 212 and having network 210 as home network.

Hence, certain users are registered as users in the first group 100 BSS 112 and some users are registered as users in the second group 200 BSS 212. It is desirable that traffic resulting from mobile service provision to each user is first and primarily registered by the respective user's BSS when the user in question is within the coverage area of the user's group 100 or 200, so that each BSS can be kept up-to-date with respect to consumption of such services.

However, when users roam between the groups 100, 200, the respective local IMSI provided to the mobile device will cause an APN to be used which points to either GGSN 111 or GGSN 211 depending on in which group 100, 200 the mobile device is currently roaming.

According to the present invention, a mobile communication device comprising a SIM card identifying itself to each network using an IMSI code, which SIM card identifies itself with different IMSI codes when roaming in different participating networks, can thus roam between at least two network groups 100, 200.

FIG. 2 illustrates the method steps of a method according to the present invention, illustrated for a mobile device having 110 as the home network.

In a step 11, the first GGSN 111 and the first BSS 112 are provided, said first GGSN 111 and said first BSS 112 being interconnected and arranged to serve mobile communication devices being provided mobile communication services in the first group 100 of networks.

In a step 12, the first BSS 112 is provided, as described above, with a user account associated with the user on the first BSS 112, which user account is henceforth kept on the first BSS 112.

In a step 13, the second GGSN 211 and the second BSS 212 are provided, said second GGSN 211 and said second BSS 212 being interconnected and arranged to serve mobile communication devices being provided mobile communication services in the second group 200 of networks, also as described above.

In a step 14, a certain mobile communication device is provided with mobile communication services in the first network group 100.

In a step 15, communications to and from the certain mobile device arising as a consequence of mobile communication services provided to the device in question in the first group 100 are routed via a first SGSN 125, 135, comprised in the first group 100 and preferably arranged within the geographical coverage area of the networks 110, 120, 130 comprised in the first group 100, and the first GGSN 111. Furthermore, the first GGSN 111 is caused to provide the first BSS 112 with usage information relating to such communications. For instance, this may take place by providing CDR:s from GGSN 111 to BSS 112.

In a step 16, the first BSS 112 is caused to update the user account data of said user account using the said received information. This updating preferably takes place continuously, as a direct consequence of the receipt of such data. For instance, digital data traffic can be continuously subtracted from a prepaid amount of data traffic registered in the said user account stored on BSS 112.

In a step 17, the certain mobile communication device roams from one of networks 110, 120, 130 in the first group 100 to one of networks 210, 220, 230 in the second group 200. Then, in a step 18, the mobile communication device is provided with mobile communication services in the second network group 200 as described above. Hence, step 18 may comprise that the mobile device is provided with a local IMSI code for network identification.

In a step 19, communications to and from the certain mobile communication device are hence routed via a second SGSN 225, 235, comprised in the second group 200 and preferably arranged within the geographical coverage area of the networks 210, 220, 230 comprised in the first group 200, and the second GGSN 211. Furthermore, the second GGSN 211 is caused to provide the second BSS 212 with usage information relating to said communications, in a way which corresponds to the provision of such information from the first GGSN 111 to the first BSS 112 as described in step 15.

Preferably as a reaction to the fact that there is no user account registered on the second BSS 212 associated with the certain mobile device, the second BSS 212 is caused, in a step 20, to not try to update such a locally stored user account with the traffic data, but instead to locate the first BSS 112 as a BSS keeping the user account data of the user of said certain mobile device.

After this localization, in a step 22 the first BSS 112 is provided, from the second BSS 212 and preferably over the internet 1, with information corresponding to said usage information relating to mobile traffic as a result of provided mobile communication services to the certain mobile device in the second group 200 of networks 210, 220, 230.

Then, in a step 23, the first BSS 112 is caused to thereupon update the above described user account using the information received from the second BSS 212. This updating is preferably essentially identical to the updating described in step 16, where the only significant difference is that the information stems from BSS 212 instead of GGSN 111.

Using a system configured in this way, and such a method, it is possible to use several local BSS instances, providing low-latency seamless service to users roaming in locally connected networks, while still keeping one single user account for each user is one location, depending on where the user in question is a subscriber. For instance, billing can then be performed correctly in the correct region.

Also, it is possible to arrange local GGSN:s in locations where it is desirable to do so, for instance in countries where there are regulatory requirements for this, without having to arrange the user account and billing functionality locally in such locations.

Hence, the above described method allows a user with a user account on BSS 112 to be provided low-latency seamless service even when roaming from group 100 to group 200. However, the opposite is also true, in that a user with a user account on BSS 212 roaming from group 200 to group 100 will be treated in the corresponding way, by the BSS 112 identifying BSS 212 as the BSS keeping the user account for that user, that communication usage information is sent, over the internet 1, from BSS 112 to BSS 212 and that the user account information is continuously updated as a response thereto in BSS 212.

According to a preferred embodiment, in a step 21, the second BSS 212 is caused to store information indicating that the user in question is associated with the first BSS 112. This results in that any additionally communicated information regarding mobile service traffic directed to the second BSS 212 and relating to the user in question will be directly transferred to the first BSS 112 by the second BSS 212. Also, any replies from the first BSS 112 to such communications are delivered back, from the second BSS 212, to the party transmitting the additional communication to the second BSS 212 in the first place. In other words, once the second BSS 212 has registered that the user in question has its user account on the first BSS 112, all communications to and from the second BSS 212 regarding the usage of that user of mobile services will be automatically forwarded to and from the first BSS 112. Hence, the second BSS 212 will in a sense act as a proxy for the first BSS 112 for this user while the user roams in the second group 200.

Once the user roams back to the first group 100, in a step 24, the method returns to step 14, and hence the situation returns to the one initially described, where communications are routed via the first GGSN 111 to the first BSS 112.

According to a particularly preferred embodiment, the above discussed registration in the second BSS 212 of the first BSS 112 as the BSS being responsible for the user account of the user currently roaming in the second group 200, in step 21, comprises that the second BSS 212 sets up a temporary internet session to the first BBS 112, over which subsequent information relating to the user in question is transmitted to the first BSS 112. It is preferred that such internet session is set to time out in case of transmittal inactivity during a certain predetermined time period, which time period may be between 10 seconds and 1 hour, more preferably between 10 seconds and 10 minutes. This provides a very convenient way of handling multiple roaming communication devices simultaneously with little overhead. If an inactive user becomes active again, the proxy link to the first BSS 112 can quickly be set up once again in the same way.

According to a preferred embodiment, the GGSN 111 is connected to an OCS (Online Charging Sever) 114, arranged to in turn communicate with the BSS 112 and to provide billing functionality with respect to users subscribing to the BSS 112. For instance, the OCS 114 may provide an interface between the GGSN 111 and the BSS 112 regarding communication information forming the basis for billing for consumed communication services, in a way which may be conventional as such. In the corresponding way, the network 210 comprises a corresponding OCS 214 with the corresponding functionality and connections. Hence, the above mentioned additionally communicated information regarding mobile service traffic directed to the second BSS 212 and relating to the user in question comprises charging information sent to the second BSS 212 from the second GGSN 211 or the OCS 214 which is connected to the second GGSN 211.

It is particularly preferred that the first 100 and the second network groups 200 are geographically separated, preferably by at least 1000 km, preferably so that their corresponding coverage areas are located in different countries, most preferably that they are located in different continents. The coverage areas of the different groups 100, 200 may be partly overlapping, but it is preferred that they are disjoint.

It is furthermore in this case preferred that the first BSS 112 is arranged at the first group 100, such as within the coverage area of the first group 100, and in that the second BSS 212 is arranged at the second group 200, such as within the coverage area of the second group 200.

Namely, the present method and system for providing seamless low-latency operation to mobile users is particularly useful in cases where groups 100, 200 of networks are operated at large geographical distances.

According to a preferred embodiment, a geographically discriminating DNS service, such as a GeoDNS service, is used for access to the BSS 112, 212 functionality by users of the system. In this case, a first DNS service, comprised in the DNS 3, is used for resolving an IP (Internet Protocol) address for the first 112 or second 212 BSS, based upon a BSS URL (Unified Resource Locator), which URL is the same when the mobile communication device is being provided mobile communication services in both the first 100 and the second 200 network group, preferably in all network groups participating in the virtual network. The said first DNS service is arranged to provide, for the given URL, the IP address of the first BSS 112 when the mobile communication device is in the coverage area of the first network group 100 and the IP address of the second BSS 212 when the mobile communication device is in the coverage area of the second network group 200. Since, for instance, a mobile device the user account of which is kept by the first BSS 112 and which is roaming in the second group 200 is already registered in the second BSS 212 for communication forwarding to the first BSS 112, any requests or any other communications pertaining to the mobile device or user account in question directed to the second BSS 212 will be automatically forwarded to the first BSS 112. The corresponding is of course also true for a user the account of which is kept by BSS 212, and the corresponding mobile device of which is currently roaming in the first group 100. Hence, a single URL can be provided to all users, irrespectively of which BSS 112, 212 is used to keep their user account, and all requests and other communications regarding the corresponding user accounts will automatically end up at the correct destination for proper assistance.

Instead of being used to access the BSS 112, 212, or in addition thereto, a uniform URL may be used to access the web servers 113, 213. In this case, the said first DNS service will resolve the single URL into a corresponding IP address of either web server 113 or web server 213, depending on the geographical location of the requester. It is preferred that the respective web server 113, 213 is arranged to provide a respective web interface presenting user account data status to the requesting user, and that a suitable interface is used by the respective web server 113, 213 for querying the respective first 112 or second 212 BSS for such data, or to forward requests for additional connectivity, and so forth, to the respective BSS 112, 212. This way, a user travelling in either one of groups 100 or 200 may use the same URL from any device, such as the user's roaming mobile communication device or a conventional computer, to access the home BSS 112 using the web server 113 or the web server 213 depending on in which group the user currently resides, without having to keep track of which web server 113, 213 to use depending on his or her current location.

To this end, it is preferred that the first 112 and second 212 BSS are each caused to provide a respective digital communication interface for querying the current status of the user account data and preferably also to send commands to affect the status of the user account data, which interface is reachable using the said uniform URL either directly or indirectly, via the corresponding web server 113, 213. For instance, a mobile communication device used with the virtual communication system may be provided with software functionality arranged to provide the user with an interface for handling account data, such as viewing usage statistics and ordering additional connectivity. In this case, such software could use the said BSS 112, 212 interface to communicate directly to the respective BSS 112, 212 via the uniform URL. Alternatively or additionally, a user could access the corresponding functionality by opening a web browser on any device, accessing the correct BSS 112, 212 via the respective web server 113, 213 by one single uniform URL, regardless of from where the user currently resides.

It is particularly preferred that the said digital communication interface provided by the corresponding BSS 112, 212 is arranged to accept commands for purchasing more connectivity for the mobile communication device in question.

Authentication may be provided by said interface in different ways, such as by using a username/password combination when communicating via web server 113, 213, or by extracting user details automatically, based upon knowledge of the requestor, when communicating directly with the BSS 112, 212.

According to one preferred embodiment, the DNS 3 function also comprises a second DNS service for resolving an IP address for an APN (Access Point Name) used by mobile devices roaming within the groups 100, 200. More particularly, the second DNS service is arranged to resolve an IP address for a first gateway, which is connected to or constitutes the first GGSN 111, or a second gateway, which is connected to or constitutes the second GGSN 211, based upon a specific APN. It is preferred that the APN is known to the mobile communication device in advance, and is the same when the mobile communication device is being provided mobile communication services in both the first 100 and the second 200 network group, preferably in all network groups participating in the virtual network. The said second DNS service is also arranged to provide, for the said particular APN, the IP address of the said first gateway when the mobile communication device is in the first network group 100 and the IP address of the sad second gateway when the mobile communication device is in the second network group 200.

Preferably, both said first and said second DNS services are geographically discriminate in the sense that they return an IP address which is local to the current geographic location of the party providing the URL and requesting a corresponding IP address.

In a particularly preferred embodiment, an IMSI to be used by the above described SIM card, arranged in the mobile communication device, for network identification when being provided mobile communication services in a certain mobile communications network, is provided from the network in question to the mobile communication device. In this and other cases, the IMSI in question is preferably associated with the said APN. In other words, the same APN is associated with the INSI used in several, preferably all, networks of several, preferably all network groups participating in the virtual network, but the APN in question is resolved, via DNS 3, to different IP addresses depending upon the geographic location of the roaming mobile device, in particular depending on the group in which the mobile device currently roams.

This way, the same APN can be used throughout the networks participating in the virtual network, while making sure that the mobile device will always be provided adequate communication services and maintaining full configuration flexibility of the virtual system.

In a particularly preferred embodiment, the above described uniform APN is used when there are several individual networks in the second network group. In this case, the said IMSI code to be used for network identification by the mobile communication device is automatically provided to the mobile device in connection to the roaming of the mobile device into the network 210, 220 or 230 in question in the second group 200, whereupon the geographically discriminate second DNS function guarantees that the communication services traffic terminates in the GGSN 211 and that the associated information thereafter reaches the BSS 112 via BSS 212, as described above.

According to a preferred embodiment, each time a BSS 112, 212 receives a communication in relation to a particular user and/or mobile communication device, it checks whether it holds a user account therefore. If not, the BSS in question automatically checks for other BSS:s that in fact keep such user account. This is preferably done by each BSS having a list of other BSS:s participating in the virtual network, and the BSS in question sending queries to the other BSS:s regarding the existence of such user accounts for the user and/or mobile device with respect to which the initial communication was made.

In particular, there are preferably at least three different BSS:s, each keeping user accounts associated with a respective different set of users and each being caused to provide an interface capable of indicating whether or not a user account is kept on the BSS in question. Hence, apart from BSS:s 112 and 212 in respective groups 100 and 200, there is at least one additional BSS in at least one additional network group (not shown in FIG. 1). Preferably, each subscriber to the virtual network has a user account with at least one, preferably exactly one, of said different BSS:s, and therefore has one of the said groups as a home group.

In this case, in an initial step 10 (see FIG. 2), each BSS is provided with a list of the other BSS:s, in particular contact information for the other BSS:s. Then, the above described localization in step 20 is performed by the second BSS 212 querying the other BSS:s whether or not the user in question has a user account on each particular BSS. The inter-BSS communication of step 22 is then set up between the second BSS 212 and the BSS responding in the positive regarding the existence of the specified user account, in the exemplifying case described above in connection to FIG. 2 the first BSS 112.

In order to handle communications between different BSS:s, it is preferred that a specific digital communication interface is provided by each BSS, arranged to handle incoming communications regarding usage data from other BSS:s acting as proxies and, in case the BSS in question acts as a proxy, for sending such communications to the BSS handling the user account in question.

Furthermore, it is preferred that each BSS is arranged with functionality for monitoring incoming communications and checking for whether there is an association in the BSS in question between a user account or mobile device to which the communication relates and another BSS for which the BSS in question acts as a proxy, and to automatically forward such identified communications to the other BSS in case such association exists, preferably without processing the service usage-related data in the communication before it is forward.

Above, preferred embodiments have been described. However, it is apparent to the skilled person that many modifications may be made to the described embodiments without departing from the basic thought of the invention.

For instance, the network topology may differ from the one shown in FIG. 1, as long as there are at least two groups of networks participating in a virtual mobile communication network comprising at least two central points each handling user accounts for subscribers to the said virtual network.

Furthermore, there may be more than three different network groups.

Thus, the invention shall not be limited to the described embodiments, but may be varied within the scope of the enclosed claims.

1-18. (canceled)

19. Method for managing user account data in a virtual mobile communication system operable in one or several participating mobile communication networks (110,120,130) belonging to a first group (100) of such networks as well as one or several mobile communication networks (210,220,230) belonging to a second group (200) of such networks, which second group comprises different networks than the first group, wherein a mobile communication device of a user can roam between said first and second network groups, which mobile communication device comprises a SIM (Subscriber Identity Module) card identifying itself to each network using an IMSI (International Mobile Subscriber Identity) code, wherein the SIM card is caused to identify itself with different IMSI codes when roaming in different participating networks, which system comprises a first gateway node (111), in the form of a GGSN (Gateway GPRS Support Node) or a PGW (Packet data network GateWay), and a first BSS (Business Support System) (112), said first gateway node and said first BSS being interconnected and arranged to serve mobile communication devices being provided mobile communication services in said first group of networks, and keeping a user account associated with the user on the first BSS, as well as a second gateway node (211), in the form of a GGSN or a PGW, and a second BSS (212), said second gateway node and said second BSS being interconnected and arranged to serve mobile communication devices being provided mobile communication services in said second group of networks, wherein a first DNS (Domain Name Server) (3) service is used for resolving an IP (Internet Protocol) address for the first (112) or second (212) BSS, alternatively a respective first (113) or second (213) web server providing a web interface presenting user account data status and being caused to query the respective first or second BSS for such data, based upon a URL (Unified Resource Locator), which URL is the same when the mobile communication device is being provided mobile communication services in the first (100) as in the second (200) network group, and
a) when the mobile communication device is provided with mobile communication services in the first network group, routing communications via a first serving node (125,135), comprised in the first group, which communications terminate in the first gateway node, causing the first gateway node to provide the first BSS with usage information relating to said communications, causing the first BSS to update the user account data using said information, and causing the first DNS service to provide, for the said URL, the IP address of the first BSS or first web server;
b) when the mobile communication device is provided with mobile communication services in the second network group, routing communications via a second serving node (225,235), comprised in the second group, which communications terminate in the second gateway node, causing the second gateway node to provide the second BSS with usage information relating to said communications, causing the second BSS to locate the first BSS as a BSS keeping the user account data of the said user and to automatically forward to the first BSS incoming communications pertaining to usage information for the mobile device or user account in question, and causing the first BSS to thereupon update the user account using the received information, and causing the first DNS service to provide, for the said URL, the IP address of the second BSS or second web server.

20. Method according to claim 19, wherein, in b), the second BSS (212) is caused to store information indicating that the user is associated with the first BSS (112), so that any additional communications directed to the second BSS and relating to the user will be directly transferred to the first BSS by the second BSS, and so that any replies from the first BSS to such communications are delivered back to the party transmitting the additional communication to the second BSS.

21. Method according to claim 20, wherein, in b), the second BSS (212) sets up a temporary internet session to the first BSS (112), over which subsequent information relating to the user is transmitted to the first BSS, and that the said temporary internet session is set to time out in case of transmittal inactivity.

22. Method according to claim 20, wherein said additional communications comprise charging information sent to the second BSS (212) from the second gateway node (211) or an OCS (Online Charging Server) (214) which is connected to the second gateway node.

23. Method according to claim 19, wherein the first (100) and the second (200) network groups are geographically separated, the first BSS (112) is arranged at the first group, and the second BSS (212) is arranged at the second group.

24. Method according to claim 19, wherein the first (112) and second (212) BSS are each caused to provide a respective digital communication interface for querying the current status of the user account data and preferably also to send commands to affect the status of the user account data, which interface is reachable using the said URL.

25. Method according to claim 24, wherein the digital communication interface is caused to accept commands for purchasing more connectivity for the mobile communication device.

26. Method according to claim 19, wherein a second DNS service (3) is used for resolving an IP (Internet Protocol) address for a first gateway connected to or being the first gateway node (111) or a second gateway connected to or being the second gateway node (211) based upon an APN (Access Point Name), which APN is known to the mobile communication device in advance and is the same when the mobile communication device is being provided mobile communication services in the first (100) as in the second (200) network group, and the second DNS service provides, for the given APN, the IP address of the first gateway when the mobile communication device is in the first network group and the IP address of the second gateway when the mobile communication device is in the second network group.

27. Method according to claim 26, wherein an IMSI to be used by the SIM card for network identification when being provided mobile communication services in a certain mobile communications network (110,120,130,210,220,230) is associated with the said APN.

28. Method according to claim 27, wherein at least the second network group (200) comprises several individual networks (210,220,230), and the said IMSI code to be used is automatically provided to the mobile communication device in connection to the roaming of the mobile communication device into the network in question.

29. Method according to claim 19, wherein there are at least three different BSS (112,212), each keeping user accounts associated with a respective different set of users and each providing an interface capable of indicating whether or not a user account is kept on the BSS in question, in an initial step, each BSS is provided with contact information for the other BSS:s, and in b), the locating action is performed by the second BSS querying the other BSS:s whether or not the user in question has a user account on each particular BSS.

30. Method according to claim 19, wherein each BSS (112,212) is arranged with functionality for monitoring incoming communications and checking for whether there is an association in the BSS in question between a user account or mobile device to which the communication relates and another BSS for which the BSS in question acts as a proxy, and to automatically forward such identified communications to the other BSS in case such association exists without processing the service usage-related data in the communication before it is forward.

31. System for managing user account data in a virtual mobile communication system operable in one or several participating mobile communication networks (110,120,130) belonging to a first group (100) of such networks as well as one or several mobile communication networks (210,220,230) belonging to a second group (200) of such networks, in which virtual mobile communication system a mobile communication device of a user can roam between said first and second network groups, which mobile communication device comprises a SIM (Subscriber Identity Module) card identifying itself to each network using an IMSI (International Mobile Subscriber Identity) code, wherein the SIM card is arranged to identify itself with different IMSI codes when roaming in different participating networks, wherein the system comprises
a first gateway node (111), in the form of a GGSN (Gateway GPRS Support Node) or a PGW (Packet data network GateWay), and a first BSS (Business Support System) (112), said first gateway node and said first BSS being interconnected and arranged to serve mobile communication devices being provided mobile communication services in said first group of networks, and keeping a user account associated with the user on the first BSS; and
a second gateway node (211), in the form of a GGSN or a PGW, and a second BSS (212), said second gateway node and said second BSS being interconnected and arranged to serve mobile communication devices being provided mobile communication services in said second group of networks;
a first DNS (Domain Name Server) (3) service, arranged to resolve an IP (Internet Protocol) address for the first (112) or second (212) BSS, alternatively a respective first (113) or second (213) web server providing a web interface presenting user account data status and being arranged to query the respective first or second BSS for such data, based upon a URL (Unified Resource Locator), which URL is the same when the mobile communication device is being provided mobile communication services in the first (100) as in the second (200) network group
wherein, when the mobile communication device is provided with mobile communication services in the first network group, the system is arranged to route communications via a first serving node (125,135), comprised in the first group, which communications terminate in the first gateway node, whereby the first gateway node is arranged to provide the first BSS with usage information relating to said communications and whereby the first BSS is arranged to update the user account data using said information, and the first DNS service is arranged to provide, for the said URL, the IP address of the first BSS or first web server; and
wherein, when the mobile communication device is provided with mobile communication services in the second network group, the system is arranged to route communications via a second serving node (225,235), comprised in the second group, which communications terminate in the second gateway node, whereby the second gateway node is arranged to provide the second BSS with usage information relating to said communications, whereby the second BSS is arranged to locate the first BSS as a BSS keeping the user account data of the said user and to automatically forward to the first BSS incoming communications pertaining to usage information for the mobile device or user account in question, and whereby the first BSS is arranged to thereupon update the user account using the received information, and the first DNS service is arranged to provide, for the said URL, the IP address of the second BSS or second web server.

32. System according to claim 31, wherein the second BSS (212) is arranged to, in connection to said locating of the first BSS (112), store information indicating that the user is associated with the first BSS, so that any additional communications directed to the second BSS and relating to the user will be directly transferred to the first BSS by the second BSS, and so that any replies from the first BSS to such communications are delivered back to the party transmitting the additional communication to the second BSS.

33. System according to claim 31, wherein the first (100) and the second (200) network groups are geographically separated, the first BSS (112) is arranged at the first group, and the second BSS (212) is arranged at the second group.

34. System according to claim 31, wherein the first (112) and second (212) BSS are each caused to provide a respective digital communication interface for querying the current status of the user account data and preferably also to send commands to affect the status of the user account data, which interface is reachable using the said URL.

35. System according to claim 34, wherein the digital communication interface is arranged to accept commands for purchasing more connectivity for the mobile communication device.

36. System according to claim 31, wherein a second DNS service (3) is arranged to resolving an IP (Internet Protocol) address for a first gateway connected to or being the first gateway node (111) or a second gateway connected to or being the second gateway node (211) based upon an APN (Access Point Name), which APN is known to the mobile communication device in advance and is the same when the mobile communication device is being provided mobile communication services in the first (100) as in the second (200) network group, and the second DNS service is arranged to provide, for the given APN, the IP address of the first gateway when the mobile communication device is in the first network group and the IP address of the second gateway when the mobile communication device is in the second network group.
